(19) United States
(12) Patent Application Publication
(10) Pub. No.: US 2022/0211206 A1
(43) Pub. Date: Jul. 7, 2022

(54) BASE ELEMENT

(71) Applicant: PAUL HETTICH GMBH & CO. KG, Kirchlengern (DE)

(72) Inventors: Daniel REHAGE, Münster (DE); Andreas MATTHES, Chemnitz (DE)

(21) Appl. No.: 17/603,626

(22) PCT Filed: Mar. 18, 2020
(86) PCT No.: PCT/EP2020/057453

§ 371 Date: Oct. 14, 2021

(30) Foreign Application Priority Data
Apr. 15, 2019 (DE) 10 2019 109 868.8

(51) Int. Cl. A47J 31/44; A47B 91/00; A47B 77/08

(52) U.S. Cl. CPC A47J 31/4403; A47B 77/08; A47B 91/005

(57) ABSTRACT

A base element for a kitchen appliance includes a base and a support panel, which can be at least partly simultaneously rotated and moved relative to the base. Running grooves, in which rolling bodies that are held in a rolling body cage are guided, are molded into mutually facing surfaces of the base and the support panel. The running grooves are shaped such that the support panel can be rotated out of a base position in a translational manner in one direction and about a rotational angle of maximally 160° in opposite rotational directions.

### BACKGROUND AND SUMMARY OF THE INVENTION

Exemplary embodiments of the present invention relate to a base element for a kitchen appliance, in particular for a hot beverage machine such as a fully automatic coffee machine, or for a storage container or a waste container.

Kitchen appliances such as fully automatic coffee machines are often placed on shelves of kitchen units. The service flaps or water or coffee bean containers of these fully automatic coffee machines are usually located in the rear area of the appliance.

For full access to the service flaps or water or coffee bean containers, the fully automatic machine must be pulled forward and, if it is located in an unfavorable position within the kitchen (niche with wall cabinets), it must also be partially rotated, which requires a great deal of effort due to the heavy weight of such fully automatic machines.

To facilitate access to these service flaps or water or coffee bean containers, some kitchen appliances have as many service flaps or water or coffee bean containers as possible arranged in the front region of the machine. It is also known to equip the kitchen appliances with glide-optimized feet or simple turntables.

Exemplary embodiments of the present invention are directed to a base element that ensures easy access to the service flaps or water or coffee bean containers with little effort, and to further develop such a kitchen appliance or a storage or waste container to ensure simplified access to the service flaps or water or coffee bean containers or storage or waste containers with little effort.

The base element according to the invention for a kitchen appliance, in particular for a fully automatic coffee machine, comprises a base panel and a support panel, which is simultaneously rotatable and displaceable relative to the base panel. Running grooves are formed in facing surfaces of the base panel and the support panel, in which rolling bodies held in a rolling body cage are guided.

A slot can be provided in the base panel or the support panel, in which a guide element of a fixing device can be guided to fix the support panel to the base panel. The slot can also have an at least partially curved shape, depending on the design of the running grooves and the resulting at least partially superimposed translational and rotational motion.

The running grooves are shaped in such a way that the support panel can be rotated translationally and through a maximum angle of rotation of 160° in each case from a basic position in opposite directions of rotation.

With such a base element, it is now possible to realize an optimal travel path for such a kitchen appliance or a storage or waste container. The base element can be integrated cost-effectively as a flat component in such a kitchen appliance or such a storage or waste container, or it can be mounted under such a kitchen appliance or storage or waste container.

Due to the possible rotation by a maximum of 160° in two opposite directions of rotation from a basic position, service flaps or storage units for water, coffee beans or the like arranged at the side or rear of a body of the kitchen appliance can be reached in a simple manner.

The movement (combined translational and rotational movement) of the kitchen appliance is made possible by the base element in a simple manner with little effort.

According to an advantageous embodiment variant, the angle of rotation in each direction of rotation is between 100° and 140°.

The combined movement of the kitchen appliance, which represents the best possible compromise between translation and rotation, allows the kitchen appliance to be arranged in a space-saving manner in a niche or corner of a kitchen unit and to be moved easily as required. In particular, this also allows easy access to service flaps or storage or control elements arranged at the rear of the kitchen appliance. In this case, the proportions of translation and rotation in the overall movement can vary over the course of the movement.

According to an advantageous further development, the support panel is attached to a shelf plate, wherein the shelf plate is arranged on the kitchen appliance, for example attached to it.

It is also conceivable to place the kitchen appliance on the shelf plate without fixing the shelf plate to the kitchen appliance.

According to a further advantageous embodiment variant, the shelf plate comprises a recess in which the support panel is accommodated. This allows the base element to be designed even flatter overall.

According to a further embodiment variant of the base element according to the invention, the running grooves of the support panel are formed as closed running grooves, while a first running groove of the base panel is formed as an open running groove and a second running groove of the base panel is formed as a closed running groove.

This optimizes the possibility of movement of the support panel relative to the base panel in such a way that a rotational movement of at least 100° in two opposite rotational directions is possible with simultaneous translational movement.

According to a further preferred embodiment variant, the rolling body cage is designed as an axially symmetrical hexagon, i.e., the rolling bodies are arranged in an axially symmetrical hexagon.

This always ensures sufficient support to support the center of gravity of the kitchen appliance.

The kitchen appliance according to the invention, having a body, a front region and at least one fillable storage unit in a rear region of the body is characterized by a base element arranged on an underside of the kitchen appliance, as described above.

In a preferred embodiment variant, the underside of the kitchen appliance is arranged on a shelf plate of the base element, which makes it possible to retrofit a kitchen appliance with such a base element in a simple manner. Alternatively, the kitchen appliance can be integrally equipped with a shelf plate of the base element.

According to an alternative embodiment variant, the support panel of the base element is attached to the underside of the kitchen appliance. Alternatively, the kitchen appliance can be integrally equipped with a support panel of the base element.

Alternatively, a base element according to the invention may be applied to a storage or waste container having at least one storage unit.

Appropriate storage or waste containers are often placed in corners or niches in the kitchen or in a piece of furniture, so that rear storage is difficult to access.

By using the base element according to the invention, if necessary, the storage or waste container can be moved in a combined translatory-rotatory manner so as to allow good access to the desired rear storage unit.

In this case, the storage or waste container can be arranged with its underside on a shelf plate of the base element or on a support panel of the base element.

Alternatively, the storage or waste container can also be integrally formed with a support panel or with a shelf plate of the base element.

### BRIEF DESCRIPTION OF THE DRAWING FIGURES

Preferred embodiment variants are explained in more detail below with reference to the accompanying drawings, wherein:

FIG. 1 shows a schematic perspective exploded view of an embodiment variant of a base element according to the invention,

FIG. 2 shows a schematic perspective view of a piece of furniture with a kitchen appliance placed thereon having a base element arranged at its base according to FIG. 1 in a basic position,

FIG. 3 shows a representation of the furniture element corresponding to FIG. 2 in an advanced position and rotated by approx. 120° in a first direction of rotation,

FIG. 4 shows a representation of the furniture element corresponding to FIG. 2 in an advanced position and rotated by approx. 120° in a direction opposite to the first direction of rotation.

### DETAILED DESCRIPTION

In the following figure description, terms such as top, bottom, left, right, front, rear, etc. refer exclusively to the exemplary representation and position of the base element, body, running grooves, base panel, rolling bodies and the like selected in the respective figures. These terms are not to be understood restrictively, i.e., these references may change due to different working positions or the mirror-symmetrical design or the like.

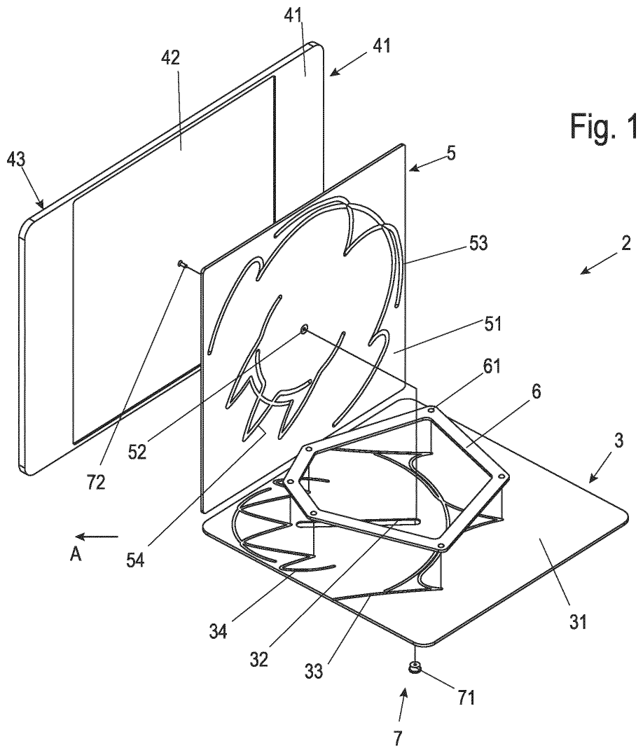

In FIG. 1, the reference sign 2 denotes one embodiment variant of a base element according to the invention. The base element 2 has at least one base panel 3 and a support panel 5 arranged so as to be simultaneously rotatable and displaceable relative to the base panel 3.

In the embodiment variant shown here, the base element 2 also has a shelf plate 4 which has a recess 42 in which the support panel 5 can be accommodated. This increases the overall thickness of the base element 2 only slightly.

The upper side 43 of the shelf plate 4 facing away from the support panel 5 is attached to the underside of a kitchen appliance.

It is also conceivable to place such a kitchen appliance on the upper side 43 of the shelf plate 4, so that the kitchen appliance stands on the shelf plate 4 in an elongated friction-fit manner and can be moved together with the shelf plate 4 and the support panel 5 relative to the base panel 3. In this case, the shelf plate 4 could have an at least partially upwardly projecting edge or an anti-slip upper side 43 to securely accommodate the kitchen appliance.

As further shown in FIG. 1, running grooves 33, 34, 53, 54 are integrally formed in mutually facing surfaces 31, 51 of the base panel 3 and the support panel 5. Rolling bodies 61 are guided in these running grooves 33, 34, 53, 54 and are captively held in a rolling body cage 6.

The rolling body cage 6 here has a hexagonal shape, with sides of equal length in pairs, i.e., the rolling bodies are arranged in an axially symmetrical hexagon. Depending on the arrangement and design of the running grooves, the rolling body cage 6 could have a different geometric shape and a different number of rolling bodies 61.

A slot 32 is provided in the base panel 3, in which a guide element 71 of a fixing device 7 can be guided for fixing the support panel 5 to the base panel 3.

In addition to the guide element 71, which is designed here as a guide bush, the fixing device 7 has a bolt 72 that rests against the underside 41 of the shelf plate 4, projects through a hole 52 in the support panel 5 and is secured to the guide element 71, for example by screwing.

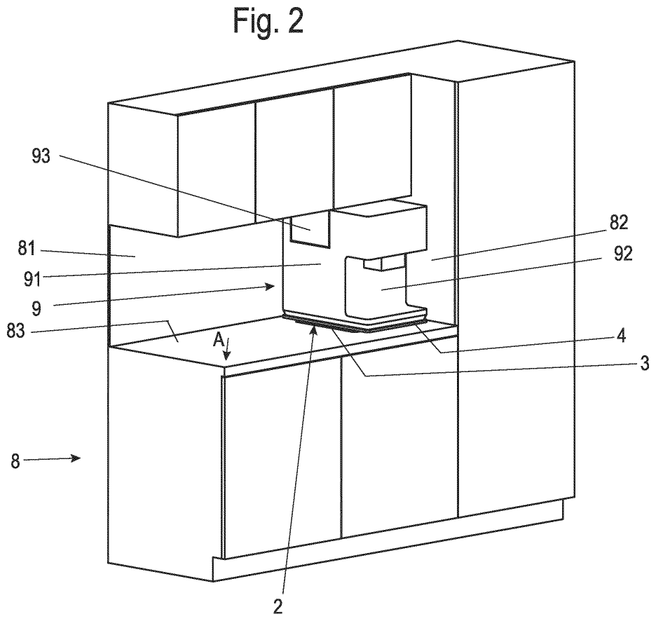

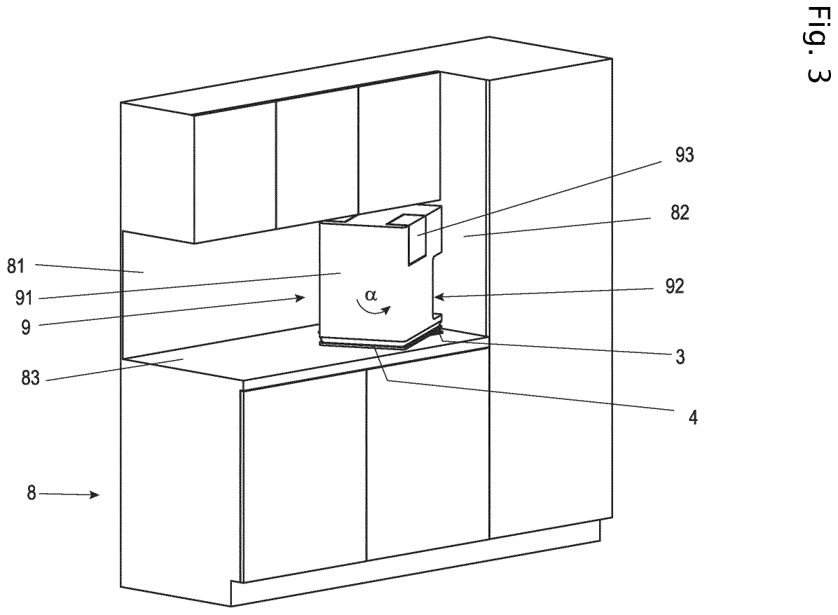

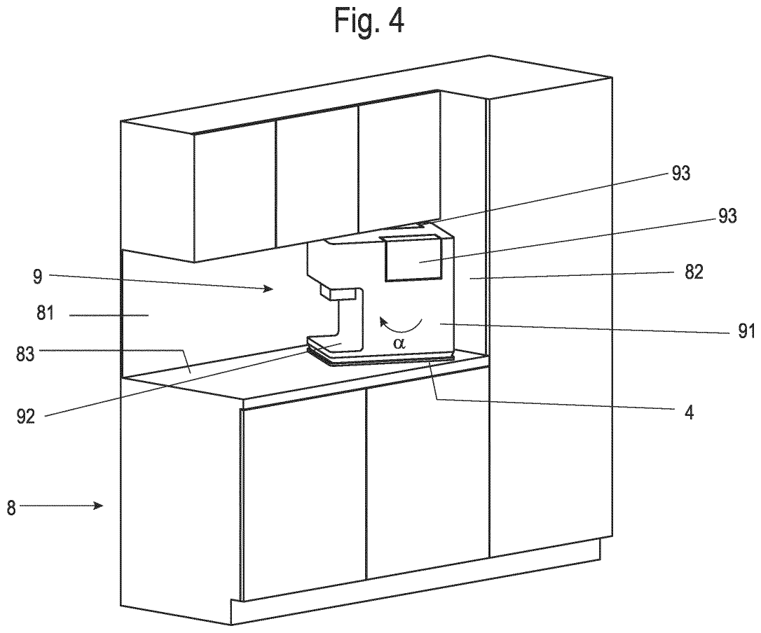

The running grooves 33, 34, 53, 54 are shaped here in such a way that the support panel 5 can be rotated translationally in the direction of the slot 32 and through a rotation angle α of at most 160° from a basic position, as shown in FIG. 2, in opposite directions of rotation, shown in FIGS. 3 and 4.

The angle of rotation α is preferably limited to a maximum angle of rotation of between 100° and 140° in each direction of rotation. In the embodiment variant shown here, the maximum angle of rotation a in each direction of rotation is preferably about 120°. The running grooves 33, 34, 53, 54 are not formed circumferentially, but represent only a pitch circle in order to realize the maximum permissible angle of rotation α. Depending on the size of the pitch circle, the maximum angle of rotation α can be larger or smaller.

To enable the rotational movement while at the same time reliably supporting the center of gravity of the support panel 5 and the kitchen appliance standing on the support panel 5 or the shelf plate 4, the running grooves of the support panel 5 are designed as closed running grooves, while a first running groove 33 of the base panel 3 is designed as an open running groove and a second running groove 34 of the base panel 3 is designed as a closed running groove.

Closed here means that the running groove does not cross an outer edge of the base panel 3.

In the embodiment example, it can also be seen that the running grooves 53, 54 of the support panel 5 are arranged concentrically or nearly concentrically in the support panel 5, whereas the running grooves 33, 34 of the base panel 3 extend from one corner of the base panel to just above half of the base panel 3.

This arrangement achieves the best possible compromise between translation and rotation, allowing the kitchen appliance to be arranged in a niche or corner of a kitchen unit in a space-saving manner and to be easily moved if necessary.

This arrangement of the running grooves 33, 34, 53, 54 ensures that the kitchen appliance does not touch any back wall or side wall of a corner or niche during the entire movement.

Such a base element 2 is arranged on the underside of a kitchen appliance 9 designed here as a fully automatic coffee machine.

As can be seen in FIG. 2, the kitchen appliance 9 is placed here on the shelf plate 4 of the base element 2. The base panel 3 stands on a worktop 83 of a piece of furniture 8 designed here as a kitchen unit. The furniture 8 can be arranged on a room wall of a kitchen room.

The worktop 83 is enclosed from two sides by a rear wall 81 and a side wall 82, which is aligned perpendicularly to the worktop 83 and the rear wall 81. The rear wall 81 or the side wall 82 can also be formed by a part of the room wall of the kitchen space.

The kitchen appliance 9 is positioned in its basic position such that it is positioned with a side wall close or tight to the side wall 82 of the piece of furniture 8.

In this context, a position of the kitchen appliance close to the side wall 82 of the piece of furniture 8 is understood as a position in which a mere rotational movement of a kitchen appliance with a cross-section that is not round in plan view, but rectangular, for example, would lead to a collision with the side wall during its rotational movement.

The kitchen appliance 9 has a body 91 with a front region 92 and two storage units 93 in the side rear region of the body 91.

In order to access this storage unit 93 of the kitchen appliance 9 in a convenient manner and without much effort, the kitchen appliance 9 is moved by simply pulling it forward in direction A and essentially simultaneously turning it sideways, for example, to the position shown in FIG. 3, in which the kitchen appliance 9 has been turned slightly forward and counterclockwise by about 120° from its basic position.

FIG. 4 shows a corresponding illustration of the rotated kitchen appliance 9 in the piece of furniture 8 in a clockwise position rotated by about 120°, so that now the storage unit 93 on the right as viewed from the front side of the kitchen appliance 9 is conveniently accessible.

Limiting the maximum angle of rotation α to 160° ensures that at least one power cable located at the rear of the kitchen appliance is not pulled out of the socket and that there is no blocking of movement by the cable when moving back to the starting position.

Kitchen equipment within the meaning of the invention is understood to include, in addition to the hot beverage machines mentioned as preferred, other devices or appliances used for processing or stocking food and/or beverages.

Thus, the use of such a kitchen appliance in a piece of furniture, in particular a kitchen unit having at least one side wall aligned at an angle, in particular at right angles, to a front side of the piece of furniture and a worktop 83 connected to the side wall 82, in which the kitchen appliance 9 is set up on the worktop 83 close to the side wall 82 in such a way that the at least one storage unit is positioned in a rear region of the body in a basic position away from the front side of the piece of furniture, is made possible by attaching or integrating a base element described above. The at least partially simultaneous translational and rotational movement of the kitchen appliance thereby made possible ensures a movement from the basic position to a position close to the front side of the piece of furniture.

Storage or waste containers having at least one storage or waste reservoir also represent a useful application for a base element according to the invention.

Thus, the use of such a storage or waste container in a piece of furniture, in particular a kitchen unit having at least one side wall aligned at an angle, in particular at right angles, to a front side of the piece of furniture, in which the storage or waste container is positioned close to the side wall 82 in such a way that the at least one storage or waste container is positioned in a rear region of the body in a basic position away from the front side of the piece of furniture, is made possible by attaching or integrating a base element described above. The at least partially simultaneous translational and rotational movement of the storage or waste container thereby made possible ensures a movement from the basic position to a position close to the front side of the piece of furniture.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

2 Base element
3 Base panel
31 Region
32 Slot
33 Running groove
34 Running groove
4 Shelf plate
41 Underside
42 Recess
43 Upper side
5 Support panel
51 Regions
52 Hole
53 Running groove
54 Running groove
6 Rolling body cage
61 Rolling bodies
7 Fixing device
71 Guide element
72 Bolt
8 Piece of furniture
81 Rear wall
82 Side wall
83 Worktop
9 Kitchen appliance
91 Body
92 Front region
93 Storage unit
A Direction
α Angle of rotation

1-16. (canceled)

17. A base element for a kitchen appliance, the base element comprising:
a base panel; and
a support panel that is at least partially simultaneously rotatable and displaceable relative to the base panel,
wherein running grooves, in which rolling bodies held in a rolling body cage are guided, are integrally formed in mutually facing surfaces of the base panel and of the support panel, and
wherein the running grooves in the mutually facing surfaces of the base panel and of the support panel are shaped in such a way that the support panel is moveable translationally in one direction and rotatable through a maximum angle of rotation of at most 160° from a basic position in mutually opposite directions of rotation.

18. The base element of claim 17, wherein the maximum angle of rotation in each direction of rotation is between 100° and 140°.

19. The base element of claim 17, wherein the support panel is fixed to a shelf plate.

20. The base element of claim 19, wherein the shelf plate has a recess in which the support panel is accommodated.

21. The base element of claim 17, wherein the running grooves of the support panel are closed running grooves, a first running groove of the base plate is an open running groove, and a second running groove of the base plate is a closed running groove.

22. The base element of claim 17, wherein the rolling bodies in the rolling body cage are arranged in an axially symmetrical hexagon.

23. The base element of claim 17, wherein the base plate or the support panel includes a slot in which a guide element of a fixing device for fixing the support panel to the base plate is guidable, and wherein the support panel can be moved in translation in the direction of the slot.

24. A system, comprising:
a kitchen appliance comprising a body, a front region, and at least one fillable storage unit; and
a base element, comprising
a base panel; and
a support panel that is at least partially simultaneously rotatable and displaceable relative to the base panel,
wherein running grooves, in which rolling bodies held in a rolling body cage are guided, are integrally formed in mutually facing surfaces of the base panel and of the support panel, and
wherein the running grooves in the mutually facing surfaces of the base panel and of the support panel are shaped in such a way that the support panel is moveable translationally in one direction and rotatable through a maximum angle of rotation of at most 160° from a basic position in mutually opposite directions of rotation, and
wherein the base element is arranged on an underside of the kitchen appliance.

25. The system of claim 24, wherein the support panel of the base element is arranged on the underside of the kitchen appliance.

26. The system of claim 24, wherein the underside of the kitchen appliance is arranged on a shelf plate of the base element.

27. The system of claim 26, wherein the shelf plate of the base element is integrally formed with the kitchen appliance.

28. The system of claim 24, wherein the support panel of the base element is integrally formed with the kitchen appliance.

29. The system of claim 24, wherein the at least one fillable storage unit is arranged in a rear region of the body.

30. A system, comprising:
a storage or waste container having at least one storage unit; and
a base element, comprising
a base panel; and
a support panel that is at least partially simultaneously rotatable and displaceable relative to the base panel,
wherein running grooves, in which rolling bodies held in a rolling body cage are guided, are integrally formed in mutually facing surfaces of the base panel and of the support panel, and
wherein the running grooves in the mutually facing surfaces of the base panel and of the support panel are shaped in such a way that the support panel is moveable translationally in one direction and rotatable through a maximum angle of rotation of at most 160° from a basic position in mutually opposite directions of rotation, and
wherein the base element is arranged on an underside of the storage or waste container.
